(19) United States
(12) Patent Application Publication
(10) Pub. No.: US 2002/0132147 A1
(43) Pub. Date: Sep. 19, 2002

(54) Chambered reactor for fuel processing

(76) Inventor: Yong Gao, Burnaby (CA)

Correspondence Address: Robert W. Fieseler, McAndrews, Held & Malloy, Ltd., 34th Floor, 500 West Madison Street, Chicago, IL, 60661, US

(21) Appl. No.: 09/811,086

(22) Filed: Mar. 16, 2001

(51) Int. Cl. H01M 8/06; B01J 8/04; C01B 3/26

(52) U.S. Cl. 429/19; 422/196; 423/652

(57) ABSTRACT

A method and apparatus for processing a hydrocarbon fuel employs at least two substantially separate reaction chambers in fluid connection within an annular cylindrical reactor tube. The annular design of the reactor tube permits increased mass flow rate for greater efficiency and lower cost processing of hydrocarbon fuel for electrochemical fuel cells and other industrial applications.

### FIELD OF THE INVENTION

The present invention relates to chemical reactors, and more particularly to methods and apparatus for catalytically reforming or converting a hydrocarbon stream to a reformate stream comprising hydrogen, and also in particular, to an apparatus comprising at least two substantially separate reaction chambers in fluid connection within a single annular reactor tube.

### BACKGROUND OF THE INVENTION

The search for alternative power sources has focused attention on the use of electrochemical fuel cells to generate electrical power. Unlike conventional fossil fuel power sources, fuel cells are capable of generating electrical power from a fuel stream and an oxidant stream without producing substantial amounts of undesirable by-products, such as sulfides, nitrogen oxides and carbon monoxide. In electrochemical fuel cells employing hydrogen as the fuel and oxygen as the oxidant, the reaction product is water. Recently, efforts have been devoted to identifying ways to operate electrochemical fuel cells using other than pure hydrogen as the fuel.

The commercial viability of fuel cell systems will benefit from the ability to efficiently and cleanly convert conventional hydrocarbon fuel sources such as gasoline, diesel, natural gas, ethane, butane, light distillates, dimethyl ether, methanol, ethanol, propane, naphtha, kerosene, and combinations thereof, to a hydrogen-rich gas stream suitable for use as the fuel gas stream to the anode of an electrochemical fuel cell with increased reliability and decreased cost. The conversion of such fuel sources to a hydrogen-rich gas stream is also important for other industrial processes. However, to be useful for fuel cells and other similar hydrogen-based chemical applications, hydrocarbon fuels should be efficiently converted to relatively pure hydrogen with a minimal amount of undesirable chemical byproducts, such as carbon monoxide.

In a fuel processing system, a catalytic hydrocarbon fuel reformer converts an hydrocarbon fuel stream and water vapor into an hydrogen-rich reformate stream. The reformate stream is generally suitable for use as the fuel gas stream to the anode of an electrochemical fuel cell after passing through a water gas shift reactor and other purification means such as a carbon monoxide selective oxidizer. In the conversion process, the raw hydrocarbon stream is typically percolated through a catalyst bed or beds contained within one or more reaction chambers mounted in the reformer vessel. The catalytic conversion process is normally carried out at elevated temperatures in the range of about 1200° F. to about 1600° F. Such elevated temperatures are generated by the heat of combustion from a burner incorporated into the reformer.

The steam reformation of methane may be represented by the following chemical equations:

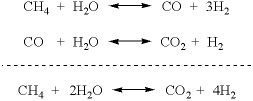

The initial gaseous mixture (reformate) produced by steam reformation of methane will contain small amounts of carbon monoxide. Water vapor will also be present in the reformate. The carbon monoxide content of the reformate may be reduced by further processing of the reformate in a shift reactor, also called a shift converter. The catalyzed reaction occurring in a shift converter is represented by the following chemical equation, sometimes referred to as the water gas shift reaction:

CO+H₂O⇄CO₂+H₂+heat

With respect to reliability and cost, conventional industrial catalytic fuel processing systems have several disadvantages. First, because conventional reformers operate at very high temperatures and pressure differentials, the reformer tubes that contain the catalyst should be constructed of rugged, thick walled portions of expensive materials capable of withstanding high temperature operating conditions. Conventional reformers also tend to be quite large and complex, which increases the cost to provide and maintain adequate plant space. Repeated thermal expansion and contraction of the reaction tubes may cause catalyst crush, decreasing efficiency and shortening service life of the reformer. Other disadvantages of conventional fuel processing systems may include uneven burner heating of the reaction tubes, low mass flow rates, and failure of internal reactor structures.

Accordingly, it would be desirable to have a hydrocarbon fuel processing system of relatively simple and efficient design, capable of high hydrogen recovery rates, and of adequate reliability, size, weight and cost for use in various industrial applications, including fuel cell applications.

### SUMMARY OF THE INVENTION

A catalytic reactor comprises a reaction vessel within which is disposed an annular catalytic reactor tube, wherein the interior volume of the reactor tube is divided into a plurality of fluidly connected chambers, wherein at least one of the chambers comprises a catalyst bed, and the reaction vessel comprises a reactant stream inlet for directing a reactant stream to at least one of the plurality of chambers and a reactant stream outlet for directing a reactant stream from at least one of the plurality of chambers. The reactant stream may comprise a hydrocarbon.

The interior volume may be defined by inner and outer walls, and at least two septa extending from the inner to the outer wall so as to define at least two chambers, wherein at least one of the at least two septa comprise an opening therein for fluid connection between adjacent of the at least two chambers. The at least two septa may comprise at least four septa, the at least two chambers may comprise at least four chambers, and at least three of the at least four septa may comprise an opening therein.

In one embodiment, the reactant stream may be directed from the inlet through a first of the chambers in a first direction and then through a second of the chambers in a second reverse direction. In another embodiment, the reactant stream may be directed in a first direction through at least two of the chambers and in a second reverse direction through at least two other of the chambers. In yet another embodiment, the reactant stream may be directed from the inlet in a first direction through a first chamber, in a second reverse direction through an adjacent second chamber, in the first direction through a next adjacent third chamber, in the second direction through a next adjacent fourth chamber, and to the outlet.

Each of the chambers may contain a catalyst bed. Each catalyst bed may comprise a different catalyst.

The catalytic reactor may comprise a burner for generating a combustion gas stream external to the reactor tube. The reactor may also comprise inner and outer burner gas sleeves adjacent the inner and outer walls for directing the combustion gas stream in proximity to the inner and outer walls.

The reactor tube may comprise primary and secondary reaction chambers, wherein the primary reaction chamber converts a reactant stream to a first reformate stream comprising hydrogen; and the secondary reaction chamber receives and converts the first reformate stream to a second reformate stream comprising hydrogen. The primary reaction chamber may be a catalytic steam reformer. The secondary reaction chamber may be a catalytic water gas shift reactor.

The catalytic reactor may comprise a reactant supply for supplying the reactant stream to the primary reaction chamber via the inlet. The reactant stream may comprise a fuel selected from the group consisting of gasoline, diesel, natural gas, ethane, butane, light distillates, dimethyl ether, methanol, ethanol, propane, naphtha, kerosene, and combinations thereof.

The catalytic reactor may further comprise a heating device for heating the reactor tube, and an oxidant supply for supplying oxidant to at least one of the primary and secondary reaction chambers.

A fuel cell power generation system may comprise the catalytic reactor and a fuel cell stack comprising at least one fuel cell fluidly connected to receive the second reformate stream comprising hydrogen from the secondary reaction chamber. The fuel cell may be a solid polymer electrolyte fuel cell.

A fuel processing method may comprise supplying a reactant stream to the catalytic reactor and operating the system to obtain the second reformate stream comprising hydrogen.

### BRIEF DESCRIPTION OF THE DRAWINGS

FIG. 1 is a vertical cross-sectional view of a catalytic reactor having an annular cylindrical reactor tube comprising two reaction chambers.

FIG. 2 is a perspective view, partially in section, of an embodiment of the catalytic reactor having an annular cylindrical reactor tube comprising four reaction chambers.

FIG. 3 is a horizontal cross-sectional view of the catalytic reactor of FIG. 2, taken in the direction of arrows 3-3 in FIG. 2.

### DETAILED DESCRIPTION OF PREFERRED EMBODIMENT(S)

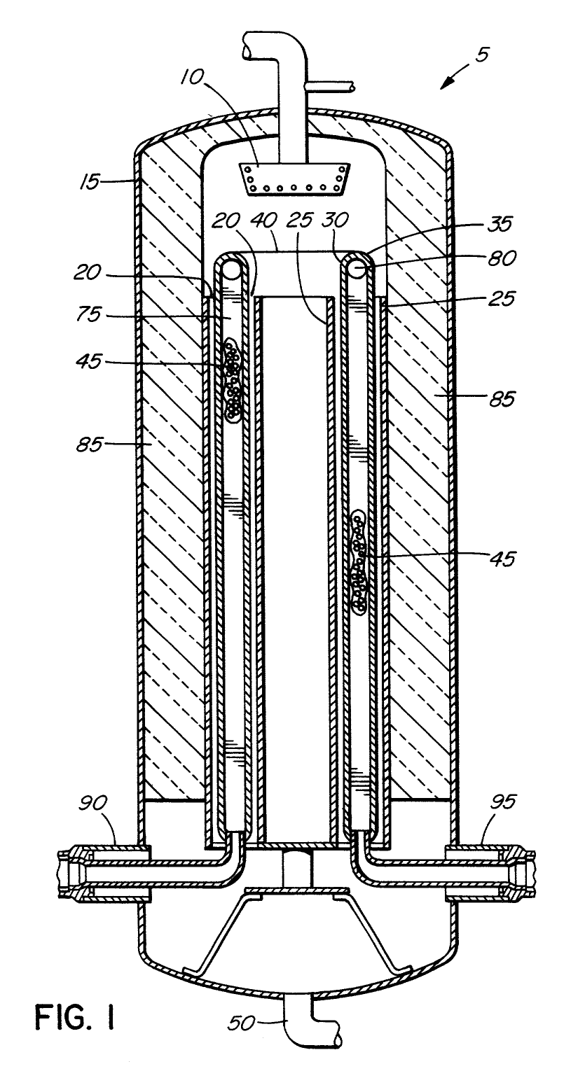

Turning first to FIG. 1, a catalytic reactor 5 includes a burner 10 located at the top of reaction vessel 15. Burner 10 is supplied with a burner gas stream composed of a fuel and an oxidant. The burner fuel gas stream is ignited at burners by a spark generator located at the end of an ignition mechanism or spark plug (not shown).

The burner fuel gas stream is combusted at burner 10 to create hot combustion gas stream which flows turbulently toward the bottom of reaction vessel 15 through narrow gaps 20 between exhaust guide sleeves 25 and inner wall 30 and outer wall 35 of annular reactor tube 40. Gaps 20 are formed sufficiently narrow so that laminar flow of the combustion gas stream is disrupted and turbulent flow is induced. Disruption of laminar flow and the inducement of turbulent flow improves heat transfer from the combustion gas stream to inner 30 and outer 35 walls of reactor tube 40 by reducing or preventing the creation of a temperature gradient across gaps 20. Laminar flow of the combustion gas stream could result in the portion of the stream toward the center of gap 20 maintaining a higher temperature than the portion of the stream flowing closer to the exterior surfaces of reactor tube 40.

Reaction vessel 15 in this embodiment enables the flow of combustion gas stream along both inner 30 and outer 35 walls of reactor tube 40 for more even heating of catalyst beds 45 disposed therein, in contrast with conventional reformer designs with combustion gas stream along only one surface. This dual heating surface enables a faster and more homogeneous reforming reaction, and increases the amount of thermal energy transferred to reactor tube 40 per unit tube length, thereby permitting use of a shorter reactor tube than is generally employed in conventional reactors.

The turbulent combustion gas stream from the burner preferably maintains the temperature in the catalyst beds 45 in the range of about 800° F. (430° C.) to about 1600° F. (870° C.) or higher. The pressure of the combustion gas stream is preferably maintained at above 1 atmosphere (98 kPa). The combustion gas stream exiting narrow gaps 20 is expelled from the interior of reactor tube 40 via external piping 50.

Reactor tube 40 may be of annular cross-section of any radial geometry. For example, the cylinders forming inner 30 and outer 35 walls of reactor tube 40 may be circular, hexagonal or octagonal in horizontal cross-section. The annular cylindrical space defined between inner 30 and outer 35 walls of reactor tube 40 may be separated into a plurality of reaction chambers (not shown in FIG. 1) by two or more septa 75. One or more of septa 75 may have an opening 80 at an upper or a lower end.

Septa 75 separate the interior of reactor tube 40 into a plurality of reaction chambers fluidly connected through openings 80 in septa 75. Choice of the number of septa and the location of the openings enables a variety of flowpath options to be configured within reactor tube 40. For example, a reactor tube may comprise two septa, each with an opening at its top end. The first and second reaction chambers so formed by the septa may both contain catalyst for steam reforming. A hydrocarbon fluid may be directed to flow upwardly through a catalyst bed in the first reaction chamber, through the openings in the septa, and in a reverse direction downwardly through a catalyst bed in the second reaction chamber before exiting reactor tube 40.

In addition to dividing the reactor tube into a plurality of reaction chambers, the septa serve as heat conductors between inner 30 and outer 35 walls of reactor tube 40. Thermal expansion and separation of reactor tube walls 30, 35 during operation of the reactor may permit catalyst beads loaded in the reaction chambers to settle. Subsequent cooling and contraction of the reactor tube may crush some of the catalyst, decreasing the service life of the reactor. The heat-conducting septa linking inner and outer walls of the reactor tube acts as a thermal bridge to reduce variation in the thermal expansion and contraction of the reactor tube, thereby decreasing catalyst crush. The septa may also improve integration of the overall reactor structure, and facilitate heat conduction through the catalyst beds.

In some conventional reformer designs, the reformer catalyst bed has a limited height. In the present embodiment of an improved reactor design, the catalyst bed(s) may completely fill the reactor tube, permitting reforming to take place near the top of the reactor in the highest thermal energy zone (approximately 1900° F. (1000° C.))

As shown in FIG. 1, insulation 85 may be disposed on the inner surface of reaction vessel 15 to reduce heat loss from the interior of reaction vessel 15 to the external environment. Insulation preferably includes a plurality of insulation layers, each having a different heat transfer coefficient appropriate for the temperature, pressure and spatial characteristics of the interior components, particularly burner and reactor tube. Insulation assembly is preferably distributed within the upper and lower areas of reaction vessel 15.

In the embodiment shown in FIG. 1, a hydrocarbon-containing reactant gas stream, preferably comprising natural gas, steam, and optionally a small amount of recycled reformate, is fed via reactant gas stream inlet 90 into a catalyst bed in a first reaction chamber within reactor tube 40 at a pressure in the range of about 20-85 psig (140-590 kPa) and a temperature of about 550° F. (290° C.) to about 1000° F. (540° C.). The reactant gas stream is percolated through catalyst bed 45 contained in first reaction chamber, where the reactant gas stream is converted into a first hydrogen-rich reformate gas stream.

Upon exiting first catalyst chamber toward the top of reactor tube 40, the first hydrogen-rich reformate gas stream passes through opening 80 and then to the bottom of reactor tube 40 through catalyst bed 45 in a second reaction chamber.

The first reformate gas stream passes through second reaction chamber and exits reactor tube 40 and vessel 15 as a second hydrogen-rich reformate stream via reformate gas stream outlet 95 and may be directed to the anode of associated electrochemical fuel cell(s), optionally via further fuel processing apparatus.

In another embodiment of a catalytic reactor, the second reaction chamber may comprise a shift reactor for removal of carbon monoxide from the reformate stream.

The increased availability of heat to the first reaction chamber during initial reforming permits an increased mass flow rate through the reactor. In the second reaction chamber, the temperature of the reaction chamber may be controlled to permit a variety of reactions to be accommodated. These may include additional steam reforming, water gas shift reaction, or other fuel processing reactions.

More efficient space design permits a smaller reactor size, which results in higher efficiency and reduced costs of fuel processing. Such a fuel processing reactor system incorporating a multi-chambered annular reactor design is also simplified relative to a multi-tube reformer by reducing the number of system components.

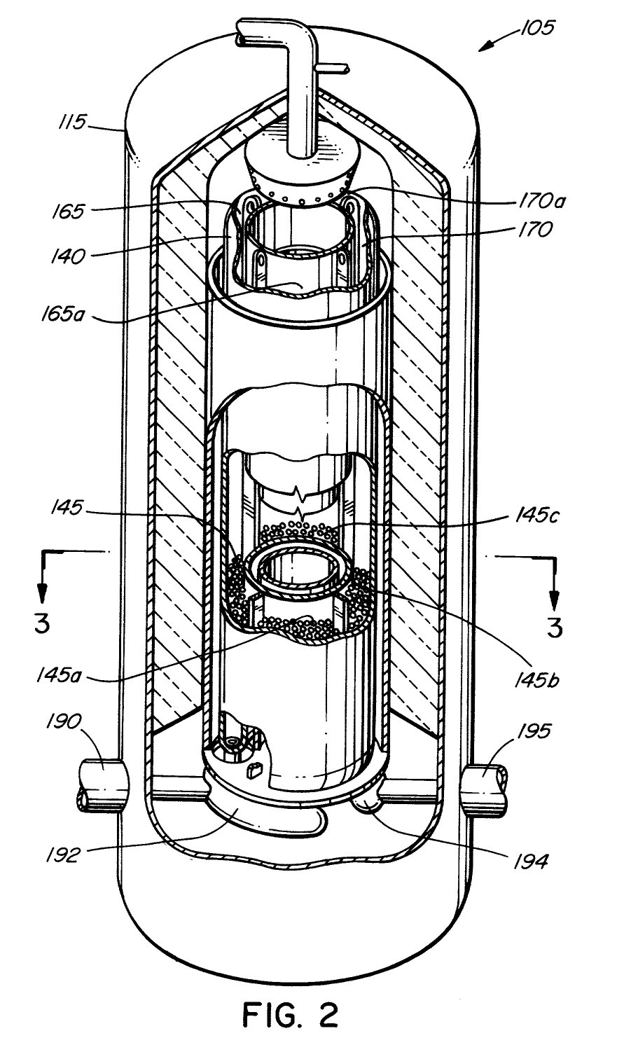

FIG. 2 shows an embodiment of a catalytic reactor 105 similar to the reactor with a two-chambered reactor tube illustrated and described in FIG. 1, but having an annular reactor tube 140 comprising four adjacent reaction chambers 165, 165a, 170, 170a. In this embodiment, the process of converting a raw hydrocarbon reactant stream to a hydrogen-rich reformate stream is carried out simultaneously in a plurality of reaction chambers. Each of the reaction chambers may contain the same or different catalysts, or multiple layers of different catalysts.

A hydrocarbon-containing reactant gas stream, which preferably comprises natural gas, steam and, optionally, a small amount of recycled reformate, enters reaction vessel 115 through reactant gas stream inlet 190 into reactant gas stream inlet toroid 192. The reactant gas stream flows from reactant gas stream inlet toroid 192 simultaneously into both first and second reaction chambers 165, 165a in reactor tube 140. The reactant gas stream is percolated through catalyst beds 145, 145a in first and second reaction chambers 165, 165a, where the reactant gas stream is converted into a first hydrogen-rich reformate gas stream.

Upon exiting first and second reaction chambers 165, 165a toward the top of reactor tube 140, the pressurized first reformate gas stream passes through openings 180 then in reverse direction through catalyst beds 145b, 145c in third and fourth reaction chambers 170, 170a.

The reformate gas stream is directed from the bottom of third and fourth reaction chambers 170, 170a to reformate gas stream outlet gas toroid 194 and exits reactor 105 as a second hydrogen-rich reformate stream via reformate gas stream outlet 195 and may be directed to the anode of the associated electrochemical fuel cell(s).

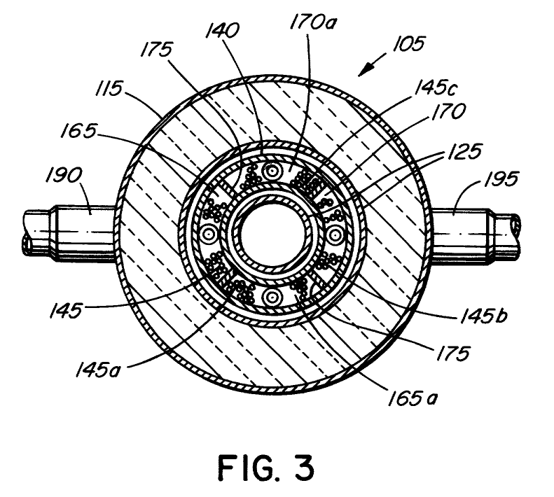

Turning now to the catalytic reactor illustrated in FIG. 3, a horizontal sectional view of reactor 105 is shown, taken in the direction of arrows 3-3 in FIG. 2. FIG. 3 shows the relative position within reaction vessel 115 of reactor tube 140, burner exhaust guide sleeves 125, reaction chambers 165, 165a, 170, 170a, catalyst beds 145, 145a, 145b, 145c, septa 175, insulation 185, reactant gas stream inlet 190 and reformate gas stream outlet 195.

In an alternative mode of operation of a four-chambered annular reactor similar to the embodiment of FIGS. 2 and 3, the reactant gas stream may be directed sequentially in a first direction through a first reaction chamber, in a reverse direction through an adjacent second reaction chamber, in said first direction through a third next adjacent reaction chamber, and finally in said reverse direction through a fourth reaction chamber before exiting the reactor.

In another embodiment, additional concentric cylinders and septa may be disposed within the reactor tube to form a secondary ring of reaction chambers internally or externally to the primary ring of reaction chambers within the reactor tube. In such an embodiment, fluid flow is preferably between adjacent reaction chambers within a ring of reaction chambers.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications as incorporate those features that come within the scope of the invention.

What is claimed is:

1. A catalytic reactor comprising a reaction vessel having disposed therewithin an annular catalytic reactor tube, said reactor tube interior volume being divided into a plurality of fluidly connected chambers, at least one of said chambers comprising a catalyst bed, said reaction vessel comprising a reactant stream inlet for directing a reactant stream to at least one of said plurality of chambers and a reactant stream outlet for directing a reactant stream from at least one of said plurality of chambers.

2. The catalytic reactor of claim 1 wherein said interior volume is defined by inner and outer walls, at least two septa extending from said inner wall to said outer wall so as to define at least two chambers, at least one of said at least two septa having an opening formed therein for effecting fluid connection between adjacent of said at least two chambers.

3. The catalytic reactor of claim 2 wherein said at least two septa comprise at least four septa, said at least two chambers comprise at least four chambers, and at least three of said at least four septa have an opening formed therein.

4. The catalytic reactor of claim 2 wherein said reactant stream is directed from said inlet through a first of said at least two chambers in a first direction and then through the second of said at least two chambers in a second direction, said second direction being substantially the reverse of said first direction.

5. The catalytic reactor of claim 3 wherein said reactant stream is directed in a first direction through at least two of said at least four chambers and in a second direction through at least two other of said at least four chambers, said second direction being substantially the reverse of said first direction.

6. The catalytic reactor of claim 3 wherein said reactant stream is directed from said inlet in a first direction through a first of said chambers, in a second direction through an adjacent second of said chambers, in said first direction through a next adjacent third of said chambers, in said second direction through a next adjacent fourth of said chambers, and to said outlet, said second direction being substantially the reverse of said first direction.

7. The catalytic reactor of claim 1 wherein each of said chambers comprises a catalyst bed.

8. The catalytic reactor of claim 7 wherein each of said chamber catalyst beds contains a different catalyst.

9. The catalytic reactor of claim 1 wherein said reactant stream comprises a hydrocarbon.

10. The catalytic reactor of claim 2 further comprising a burner for generating a combustion gas stream within said reaction vessel, said combustion gas stream being external with respect to said reactor tube.

11. The catalytic reactor of claim 10 further comprising inner and outer burner gas sleeves adjacent said inner and outer walls, respectively, for directing said combustion gas stream in proximity to said inner and outer walls.

12. The catalytic reactor of claim 1 wherein said reactor tube comprises primary and secondary reaction chambers, said primary reaction chamber converting a reactant stream to a first reformate stream comprising hydrogen, said secondary reaction chamber receiving and converting said first reformate stream to a second reformate stream comprising hydrogen.

13. The catalytic reactor of claim 12 wherein said primary reaction chamber is a catalytic steam reformer.

14. The catalytic reactor of claim 13 wherein said secondary reaction chamber is a catalytic water gas shift reactor.

15. The catalytic reactor of claim 12, further comprising a reactant supply for supplying said reactant stream to said primary reaction chamber via said inlet.

16. The catalytic reactor of claim 12 wherein said reactant stream comprises a fuel selected from the group consisting of gasoline, diesel, natural gas, ethane, butane, light distillates, dimethyl ether, methanol, ethanol, propane, naphtha, kerosene, and combinations thereof.

17. The catalytic reactor of claim 12 further comprising a burner for generating a combustion gas stream external to said reactor tube.

18. The catalytic reactor of claim 13 further comprising inner and outer burner gas sleeves adjacent said inner and outer walls, respectively, for directing said combustion gas stream in proximity to said inner and outer walls.

19. The catalytic reactor of claim 12, further comprising an oxidant supply for supplying oxidant to at least one of said primary and secondary reaction chambers.

20. A fuel cell power generation system comprising:
a catalytic reactor comprising a reaction vessel having disposed therewithin an annular catalytic reactor tube, said reactor tube interior volume being divided into a plurality of fluidly connected chambers, one of said plurality of chambers being a primary reaction chamber and another of said plurality of chambers being a secondary reaction chamber, said primary reaction chamber comprising a catalyst bed for converting a reactant stream to a first reformate stream comprising hydrogen, said secondary reaction chamber receiving and converting said first reformate stream to a second reformate stream comprising hydrogen, said reaction vessel comprising a reactant stream inlet for directing a reactant stream to at least one of said plurality of chambers and a reactant stream outlet for directing said second reformate stream from at least one of said plurality of chambers, and
a fuel cell stack comprising at least one fuel cell fluidly connected to said catalytic reactor such that said second reformate stream is directed to said at least one fuel cell.

21. The fuel cell power generation system of claim 20 wherein said at least one fuel cell is a solid polymer electrolyte fuel cell.

22. A fuel processing method comprising:
(1) supplying a reactant stream to a catalytic reactor comprising a reaction vessel having disposed therewithin an annular catalytic reactor tube, said reactor tube interior volume being divided into a plurality of fluidly connected chambers, one of said plurality of chambers being a primary reaction chamber and another of said plurality of chambers being a secondary reaction chamber, said primary reaction chamber comprising a catalyst bed for converting a reactant stream to a first reformate stream comprising hydrogen, said secondary reaction chamber receiving and converting said first reformate stream to a second reformate stream comprising hydrogen, said reaction vessel comprising a reactant stream inlet for directing a reactant stream to at least one of said plurality of chambers and a reactant stream outlet for directing said second reformate stream from at least one of said plurality of chambers, and
(b) operating said system to obtain said second reformate stream comprising hydrogen.
